(19) United States
(12) Patent Application Publication
(10) Pub. No.: US 2020/0322293 A1
(43) Pub. Date: Oct. 8, 2020

(54) INFORMATION PROCESSING SYSTEM AND METHOD

(71) Applicant: iiNumbers, Inc., Taipei City (TW)

(72) Inventor: Chia-Chi Chang, Taipei City (TW)

(21) Appl. No.: 16/832,531

(22) Filed: Mar. 27, 2020

Related U.S. Application Data
(60) Provisional application No. 62/828,510, filed on Apr. 3, 2019.

(51) Int. Cl. H04L 12/58

(52) U.S. Cl. CPC H04L 51/046; H04L 51/10; H04L 51/08

(57) ABSTRACT

Disclosed is an information processing system and method, applicable to the network real-time messaging software environment. When using the information processing system of the present invention to perform an information processing method, the first step is to perform an initial operation to connect at least one real-time messaging software to the network. Then, the step is to perform a service action to proceed the message service of dialogue information and/or exchange information between each other by utilizing the dialog box of the user interface of the at least one real-time messaging software, or to proceed the business services provided by one party of the at least two users for the other party. The present invention not only can provide the message service of dialogue and/or exchange information between different users using the same real-time messaging software, but also between different users using the different real-time messaging software.

### CROSS-REFERENCE TO RELATED APPLICATION

This application claims the priority of U.S. provisional application No. 62/828,510, filed Apr. 3, 2019, which is incorporated herewith by reference.

### BACKGROUND OF THE INVENTION

### 1. Field of the Invention

The technical field generally relates to a information processing system and method, and in particular, to an information processing system and method, applicable to the network real-time messaging software environment, wherein the information processing system and method of the present invention not only can provide the message service and the business services between different users using the same real-time messaging software, but also between different users using the different real-time messaging software.

### 2. The Prior Arts

In the current commercial use of real-time messaging software, for example, in the case of LINE, LINE @ is one of the important channels for many corporate brand management communities, for providing a better personalized service experience, many companies have introduced the ChatBot (Chat Robot) technology, and, in order to expand business applications, different application program interfaces APIs can be opened for concatenation, allowing enterprises to send more customized information to customers.

As for the ChatBot, when the ChatBot is unable to handle customer service issues, it will provide a phone number for customers to call and transfer to live customer service. In this process, it is necessary to constantly jump the screen and cause inconvenience.

As for the LINE, the new “Call API” function can directly transfer internet voice calls in the chat room. That is, the users can directly call real human customer service through the official LINE account, and all the needs can be accomplished in the same screen.

However, nowadays, as for the login of the real-time messaging software such as, Line, Facebook, Wechat, WhatsApp, Telegram, KakaoTalk Messenger, integrated into the application (App), the ChatBot service is firstly provided. And when the ChatBot can not handle customer service issues, it is either to provide a phone number for customers to call and transfer to live customer service, or, as for the newly provided “Call API”, it is directly transferred to the internet voice call service in the chat room for directly calling the live customer service through the LINE official account.

However, as for users who utilize the Apps integrated with the login of real-time messaging software (for example, LINE), they can not get a one-to-one live service experience on business services, but must use the ChatBot service, or, must call the live customer service through the official LINE account in a manner similar to the traditional telephone customer service.

Meanwhile, the most important issue is that users using the application integrated with the login of real-time messaging software (for example, LINE) can not directly communicate with users utilizing another real-time messaging software (for example, WeChat) across platforms.

In other words, a user using an application integrated with the login of real-time messaging software, for example, LINE, can only communicate with another user who also uses LINE, but can not communicate with users who use WeChat for real-time messaging.

That is, as for present LINE@ commercial use, it is impossible to provide commercial services, such as financial loans, financial commodity information services, chat matching services, etc., to WeChat users, and it is not possible to provide commercial services across different real-time messaging software platforms.

Taiwan Patent No. 1649668 “Method of authentication and dialogue robot based on real-time messaging program” disclosed a method of authentication based on real-time messaging programs, which includes the following steps: Step A for receiving a first message sent from an account of an real-time messaging program through the real-time messaging program by a communication interface, wherein the first message includes a first identity data of a client; Step B for analyzing the first message by a processor to receive the first identity data; Step C for searching a client database storing a plurality of client data by a controller, so as to determine whether the first identity data uniquely corresponds to any of the client data, and if the first identity data uniquely corresponds to a specific client data, recording the account of the real-time messaging program into the client database in combination with the specific client data.

Taiwan Patent No. 1646850 “Event pushing method and electronic device thereof and event pushing system” disclosed an event pushing method and electronic device thereof. The event pushing method includes: obtaining a location information corresponding to each of a plurality of electronic devices, and displaying the identification information of the electronic devices on a map according to the location information; receiving an input signal to select a plurality of first electronic devices from the electronic devices on the map, wherein the input signal is input by an event initiating device of the electronic devices; pushing an event to the first electronic devices, the event including a designated location information designated by the event initiating device; and receive a response message of the first electronic devices, wherein the response message includes a confirm message or a reject message.

Taiwan Patent No. 1598801 “Real-time communication interaction method whereby the user is allowed to enter text message on an image when the image is transmitted by a real-time communication application program of an electronic device” disclosed a real-time communication interaction method. A user can voluntarily input a text message on an image when the image is transmitted by a real-time communication application program of an electronic device, while the other real-time communication application program is used for regulating the resolution ratio of the image displayed on a display unit according to the resolution ratio of the display unit when the other user starts the other real-time communication application program by the other electronic device, and the image contains the text message when the image is displayed on the display unit.

Taiwan Publication No. 201636836 “Method for providing network service and network service station using the same” disclosed a method for providing a network service. The method includes the following steps. Firstly, establishing a network service platform for a user to create a workspace. At least one unified matter is allowed to be added in or removed from a projectable space instance which is used to model the workspace and arranged in a back-end system of the network service platform. In which, the projectable space instance is parsed by a projector when at least one machine acquires the projectable space instance through a URI, so that a projected workspace corresponding to the workspace is built on the at least one machine for providing interaction between the user and/or another user and the projected workspace or dynamically configuring a function of the at least one machine. Besides, a network service station using the above-mentioned method is also provided.

Therefore, the issues remained to be solved include how to let users who utilize the Apps integrated with the login of real-time messaging software (for example, LINE) get a one-to-one live service experience on business services without using ChatBot service, or without calling the live customer service through the official LINE account in a manner similar to the traditional telephone customer service, and how to let users use the application integrated with the login of real-time messaging software (for example, LINE), and directly communicate with users utilizing another real-time messaging software (for example, WeChat) across platforms for real-time messaging to let users get commercial services by using the same real-time messaging software, or by using different real-time messaging software across platforms.

### SUMMARY OF THE INVENTION

A main object of the present invention is to provide an information processing system and method, applicable to the network real-time messaging software environment. When using the information processing system of the present invention to perform an information processing method, the first step is to perform an initial operation, wherein at least one real-time messaging software used by at least two users is connected to the network. Then, the step is to perform a service action, wherein the at least two users use the at least one real-time messaging software connected to the internet to proceed a message service of dialogue information and/or exchanging information between each other by utilizing a dialog box of an user interface of the at least one real-time messaging software, or to proceed business services provided by one party of the at least two users for the other party of the at least two users. That is, in the service action, the at least two users use the at least one real-time messaging software connected to the internet to proceed the message service of dialogue information and/or exchanging information between each other by utilizing the dialog box of the user interface of the at least one real-time messaging software, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party.

Another object of the present invention is to provide an information processing system and method, applicable to the network real-time messaging software environment, and to let users get the message service of dialogue information and/or exchanging information, and/or business services between different users by using the same real-time messaging software, or by using different real-time messaging software across platforms.

Another object of the present invention is to provide an information processing system and method, applicable to the network real-time messaging software environment, and to let users who utilize the Apps integrated with the login of real-time messaging software (for example, LINE) get a one-to-one live service experience on the message service and/or business services without using ChatBot service, or without calling the live customer service through the official LINE account in a manner similar to the traditional telephone customer service.

Yet another object of the present invention is to provide an information processing system and method, applicable to the network real-time messaging software environment, and to let users use the application integrated with the login of real-time messaging software (for example, LINE) and directly communicate with users utilizing another real-time messaging software (for example, WeChat) across platforms for the real-time message service and/or to let users get the real-time commercial services by using the same real-time messaging software, or by using different real-time messaging software across platforms.

To achieve the aforementioned objects, the present invention provides a information processing system, comprising: a service module, and a database, wherein the information processing system is an application or included by an application, and the login of real-time messaging software (for example, LINE) is integrated into the application in operations

The service module connects the at least one real-time messaging software used by the at least two users to the network. Each of the at least two users can input information by using the dialog box of the user interface of the at least one real-time messaging software connected to the internet to immediately communicate with each other.

The service module would proceed the input information to let the at least two users use the dialog box of the user interface of the at least one real-time messaging software to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party, wherein the dialogue information is input by at least one of the at least two users, and, the response information in response to the dialogue information is input by other users than the at least one of the at least two users, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database by the service module and/or read by the service module from the database, and/or, immediately input and/or attached by the at least two users using the dialog box of the user interface of the real-time messaging software.

The database operates with the service module and can store the dialogue information and/or the exchanging information, and/or the response information.

When using the information processing system of the present invention to perform an information processing method, the first step is to perform an initial operation, wherein at least one real-time messaging software used by at least two users is connected to the network by using the service module.

Then, the step is to perform a service action, wherein the at least two users use the at least one real-time messaging software connected to the internet to proceed the message service of dialogue information and/or exchanging information between each other by utilizing the dialog box of the user interface of the at least one real-time messaging software, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party.

Each of the at least two users can input information by using the dialog box of the user interface of the at least one real-time messaging software connected to the internet to immediately communicate with each other. The service module would proceed the input information to let the at least two users use the dialog box of the user interface of the at least one real-time messaging software to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party, wherein the dialogue information is input by at least one of the at least two users, and, the response information in response to the dialogue information is input by other users than the at least one of the at least two users.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 is a schematic view of an information processing system according to present invention;

FIG. 2 is a flowchart to illustrate an information processing method by utilizing the information processing system in FIG. 1 of the present invention;

FIG. 3 is a schematic view of an embodiment of the information processing system according to present invention;

FIG. 4 is a flowchart to illustrate an embodiment of the information processing method by utilizing the embodiment of the information processing system of the present invention in FIG. 3;

FIG. 5 is a schematic view of another embodiment of the information processing system according to present invention;

FIG. 6 is a flowchart to illustrate another embodiment of the information processing method by utilizing the embodiment of the information processing system of the present invention in FIG. 5;

FIG. 7 is a schematic view of another embodiment of the information processing system according to present invention; and

FIG. 8 is a flowchart to illustrate another embodiment of the information processing method by utilizing the embodiment of the information processing system of the present invention in FIG. 7.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

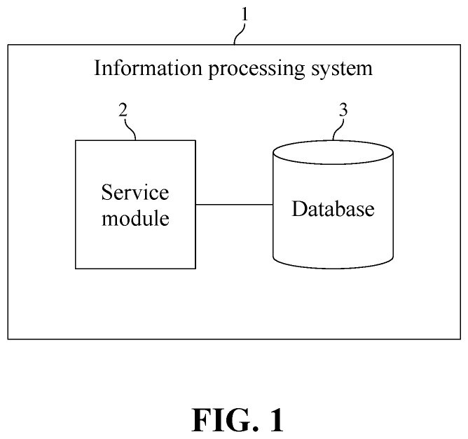

FIG. 1 is a schematic view of an information processing system according to present invention. As shown in FIG. 1, an information processing system 1 comprises a service module 2, and a database 3, wherein the information processing system 1 is an application or included by an application, and the login of real-time messaging software (for example, LINE) is integrated into the application in operations.

The service module 2 connects the at least one real-time messaging software used by the at least two users to the network. Each of the at least two users can input information by using the dialog box of the user interface of the at least one real-time messaging software connected to the internet to immediately communicate with each other.

The service module 2 would proceed the input information to let the at least two users use the dialog box of the user interface of the at least one real-time messaging software to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party, wherein the dialogue information is input by at least one of the at least two users, and, the response information in response to the dialogue information is input by other users than the at least one of the at least two users, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database 3 by the service module 2 and/or read by the service module 2 from the database 3, and/or, immediately input and/or attached by the at least two users using the dialog box of the user interface of the real-time messaging software.

The database 3 operates with the service module 2 and can store the dialogue information and/or the exchanging information, and/or the response information.

As for the Apps integrating the login of real-time messaging software (for example, LINE), to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party, the users get a one-to-one live service experience on the information service and/or the business services without using ChatBot service, or without calling the live customer service through the official LINE account in a manner similar to the traditional telephone customer service.

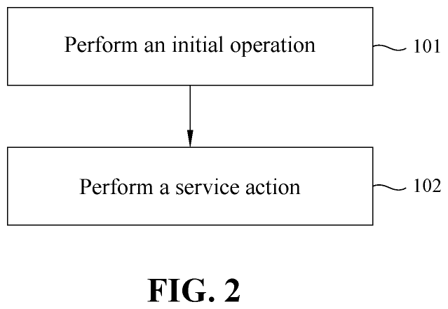

FIG. 2 is a flowchart to illustrate an information processing method by utilizing the information processing system in FIG. 1 of the present invention. As shown in FIG. 2, step 101 is to perform an initial operation, wherein the service module 2 connects the at least one real-time messaging software used by the at least two users to the network; and then proceed to Step 102.

Step 102 is to perform a service action, wherein the at least two users use the at least one real-time messaging software connected to the internet to proceed the message service of dialogue information and/or exchanging information between each other by utilizing the dialog box of the user interface of the at least one real-time messaging software, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party.

Each of the at least two users can input information by using the dialog box of the user interface of the at least one real-time messaging software connected to the Internet to immediately communicate with each other. The service module 2 would proceed the input information to let the at least two users use the dialog box of the user interface of the at least one real-time messaging software to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by one party of the at least two users for the other party, and wherein the dialogue information is input by at least one of the at least two users, and, the response information in response to the dialogue information is input by other users than the at least one of the at least two users.

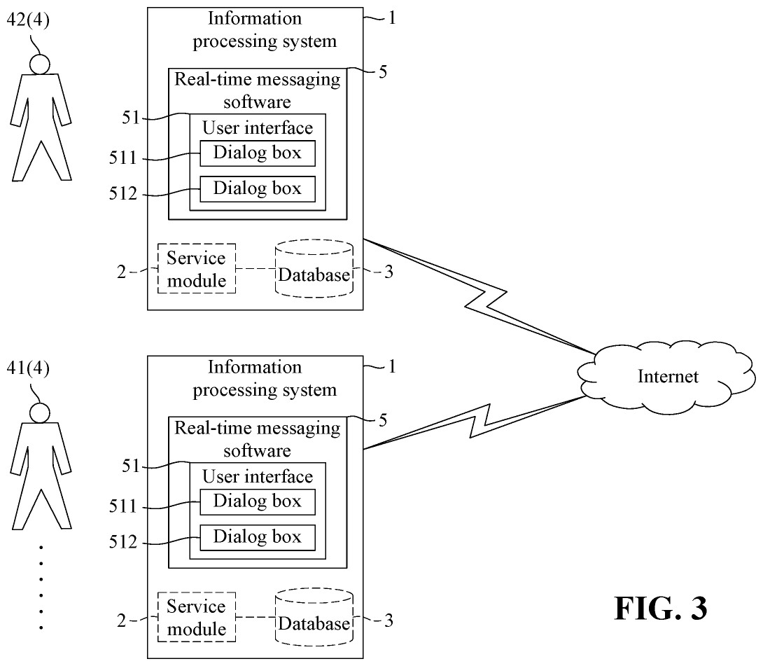

FIG. 3 is a schematic view of an embodiment of the information processing system according to present invention. As shown in FIG. 3, an information processing system 1 comprises a service module 2, and a database 3, wherein the information processing system 1 is an application or included by an application, and the login of real-time messaging software 5 is integrated into the application in operations.

The service module 2 connects the at least one real-time messaging software 5 used by the at least two users 4 to the network.

Each of the at least two users 4 can input information by using the dialog box 511 or the dialog box 512 of the user interface 51 of the at least one real-time messaging software 5 connected to the internet to immediately communicate with each other. The service module 2 would proceed the input information to let the at least two users 4 use the dialog box 511 or the dialog box 512 of the user interface 51 of the at least one real-time messaging software 5 to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by an user 42 of one party of the at least two users 4 for at least one user 41 of the other party of the at least two users 4, wherein the dialogue information is input by the at least one user 41 of the at least two users 4 by utilizing the dialog box 511 of the user interface 51 of the real-time messaging software 5, and, the response information in response to the dialogue information is input by the user 42 by utilizing the dialog box 512 of the user interface 51 of the real-time messaging software 5, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database 3 by the service module 2 and/or read by the service module 2 from the database 3, and/or, the dialogue information is immediately input and/or attached by the at least one user 41 utilizing the dialog box 511 of the user interface 51 of the real-time messaging software 5, and the response information is immediately input and/or attached by the user 42 utilizing the dialog box 512 of the user interface 51 of the real-time messaging software 5.

The database 3 operates with the service module 2 and can store the dialogue information and/or the exchanging information, and/or the response information.

In this embodiment, the at least one real-time messaging software 5 can be a single real-time messaging software, such as LINE, or the real-time messaging software 5 can also be different real-time messaging software, such as LINE, WeChat, etc., depending on the actual implementation of the present invention.

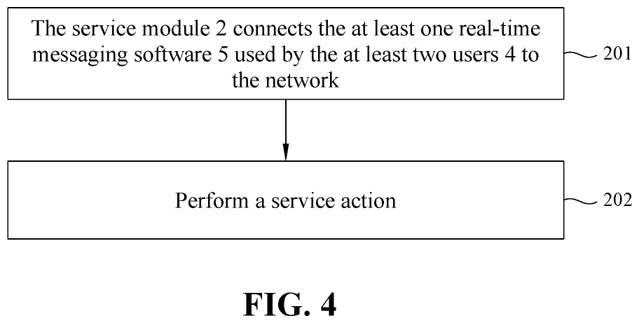

FIG. 4 is a flowchart to illustrate an embodiment of the information processing method by utilizing the embodiment of the information processing system of the present invention in FIG. 3. As shown in FIG. 4, step 201 is to perform an initial operation, wherein the service module 2 connects the at least one real-time messaging software 5 used by the at least two users 4 to the network; and then proceed to Step 202.

Step 202 is to perform a service action, where each of the at least two users 4 can input information by using the dialog box 511 or the dialog box 512 of the user interface 51 of the at least one real-time messaging software 5 connected to the internet to immediately communicate with each other. The service module 2 would proceed the input information to let the at least two users 4 use the dialog box 511 or the dialog box 512 of the user interface 51 of the at least one real-time messaging software 5 to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by an user 42 of one party of the at least two users 4 for at least one user 41 of the other party of the at least two users 4, wherein the dialogue information is input by the at least one user 41 of the at least two users 4 by utilizing the dialog box 511 of the user interface 51 of the real-time messaging software 5, and, the response information in response to the dialogue information is input by the user 42 by utilizing the dialog box 512 of the user interface 51 of the real-time messaging software 5,

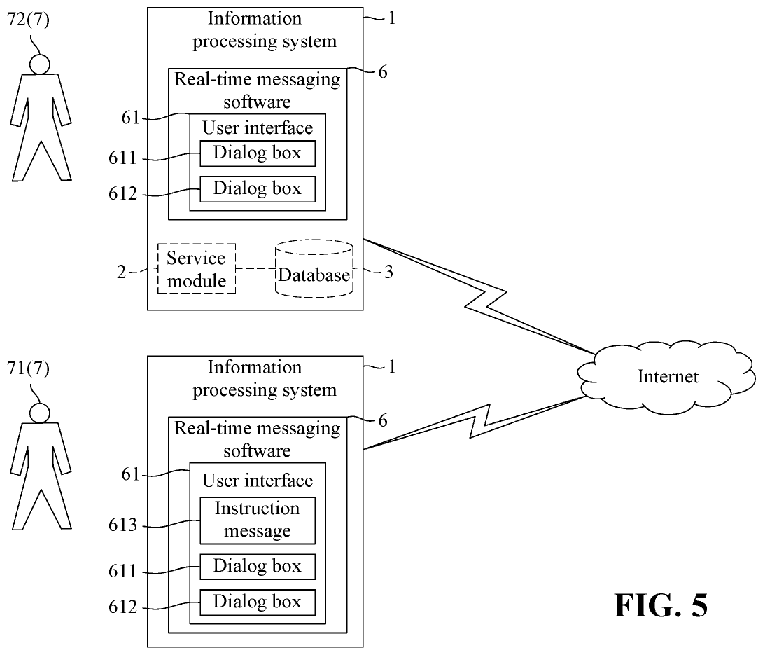

FIG. 5 is a schematic view of another embodiment of the information processing system according to present invention. As shown in FIG. 5, an information processing system 1 comprises a service module 2, and a database 3, wherein the information processing system 1 is an application or included by an application, and the login of real-time messaging software 6, for example, LINE, is integrated into the application in operations.

The service module 2 connects the same real-time messaging software 6, for example, LINE, used by the at least two users 7 to the network. The at least two users 7 can input information by using the dialog box 611 or the dialog box 612 of the user interface 61 of the same real-time messaging software 7 connected to the internet to immediately communicate with each other.

The service module 2 would proceed the input information to let the at least two users 7 use the dialog box 611 or the dialog box 612 of the user interface 61 of the same real-time messaging software 6 to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by an user 72 of one party of the at least two users 7 for at least one user 71 of the other party of the at least two users 7, wherein the dialogue information is input by the at least one user 71 of the at least two users 7 by utilizing the dialog box 611 of the user interface 61 of the real-time messaging software 6, and, the response information in response to the dialogue information is input by the user 72 by utilizing the dialog box 612 of the user interface 61 of the real-time messaging software 6, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database 3 by the service module 2 and/or read by the service module 2 from the database 3, and/or, the dialogue information is immediately input and/or attached by the at least one user 71 utilizing the dialog box 611 of the user interface 61 of the real-time messaging software 6, and the response information is immediately input and/or attached by the user 72 utilizing the dialog box 612 of the user interface 61 of the real-time messaging software 6.

The database 3 operates with the service module 2 and can store the dialogue information and/or the exchanging information, and/or the response information.

As the real-time messaging software 6 is LINE, the at least one users 71 use the user interface 61 of friend ID and/or group ID of the real-time messaging software 6 (for example, LINE), and, according to the instruction message 613 of the service mode displayed in the user interface 61, input an operation message in the user dialog 611.

After the service module 2 receives the instruction message 613, an initial operation is performed, and the messaging service and/or the business service of the service mode provided by the user 72 account ID of the group ID and/or the friend ID of the real-time messaging software 6 is activated. After the messaging service and/or business service of the service mode is activated, a service action is performed. The at least one users 71 use the dialog box 611 of the user interface 61 of friend ID and/or group ID of the real-time messaging software 6 (for example, LINE) to input dialogue information.

The service module 2 receives the dialogue information and displays the dialogue information on the user interface 61 owned by the user 72 account ID of the group ID and/or the friend ID.

The response information in response to the dialogue information in the dialogue box 611 of the user interface input by the at least one user 71 is input in the dialog box 612 of the user interface 61 by the user 72 having the account ID to provide the service mode of the information service and/or the business services, wherein the user dialogue box 611, and the dialogue box 612 owned by the account ID are inside the same user interface 61 of the real-time messaging software 6, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database 3 by the service module 2 and/or read by the service module 2 from the database 3, and/or, the dialogue information is immediately input and/or attached by the at least one user 71 utilizing the dialog box 611 of the user interface 61 of the real-time messaging software 6, and the response information is immediately input and/or attached by the user 72 utilizing the dialog box 612 of the user interface 61 of the real-time messaging software 6.

The database 3 operates with the service module 2 and can store the dialogue information and/or the exchanging information, and/or the response information.

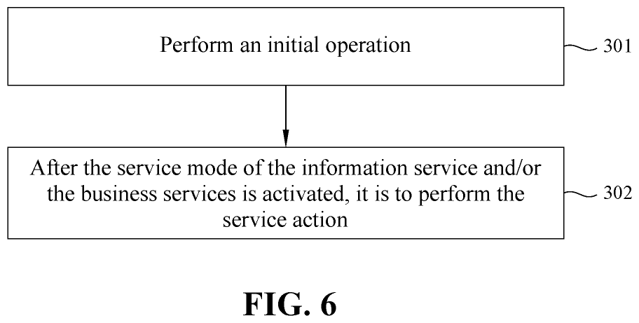

FIG. 6 is a flowchart to illustrate another embodiment of the information processing method by utilizing the embodiment of the information processing system of the present invention in FIG. 5. As shown in FIG. 6, step 301 is to perform an initial operation, wherein the service module 2 connects the at least one real-time messaging software 6 used by the at least two users 7 to the network; as the real-time messaging software 6 is LINE, the at least one users 71 use the user interface 61 of friend ID and/or group ID 61 of the real-time messaging software 6 (for example, LINE), and, according to the instruction message 613 of the service mode displayed in the user interface 61, input an operation message in the user dialog 611; after the service module 2 receives the instruction message 613, an initial operation is performed, and the information service and/or the business service of the service mode provided by the user 72 account ID of the group ID, and/or the friend ID of the real-time messaging software 6 is activated; and then proceed to Step 302.

Step 302 is to perform service action; after the service mode of the information service and/or the business services is activated, it is to perform the service action.

The at least one users 71 can use the dialog box 611 of the user interface 61 of friend ID and/or group ID of the real-time messaging software 6 (for example, LINE) to input dialogue information. The service module 2 receives the dialogue information and displays the dialogue information on the user interface 61 owned by the user 72 account ID of the group ID and/or the friend ID. The response information in response to the dialogue information in the dialogue box 611 of the user interface input by the at least one user 71 is input in the dialog box 612 of the user interface 61 by the user 72 having the account ID to provide the service mode of the information service and/or the business services.

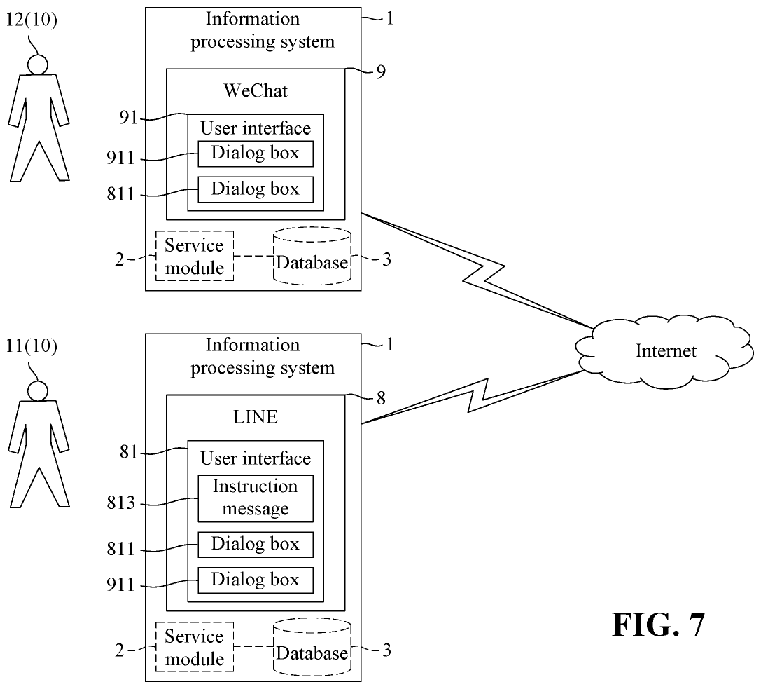

FIG. 7 is a schematic view of another embodiment of the information processing system according to present invention. As shown in FIG. 7, an information processing system 1 comprises a service module 2, and a database 3, wherein the information processing system 1 is an application or included by an application, and the information processing system 1 integrates the login of real-time messaging software 8, for example, LINE, and the login of real-time messaging software 9, for example, WeChat, into the application, respectively, in operations.

The service module 2 connects the real-time messaging software 8, 9, used by the at least two users 10, to the network, respectively. The at least two users 10 can input information by using the dialog box 811 of the user interface 81 of the real-time messaging software 8, or the dialog box 911 of the user interface 91 of the real-time messaging software 9 connected to the Internet, respectively, to immediately communicate with each other.

The service module 2 would proceed the input information to let the at least two users 10 use the dialog box 811 of the user interface 81 of the real-time messaging software 8, or the dialog box 911 of the user interface 91 of the real-time messaging software 9 to input dialogue information and/or response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by an user 12 of one party of the at least two users 10 for at least one user 11 of the other party of the at least two users 10, wherein the dialogue information is input by the at least one user 11 of the at least two users 10 by utilizing the dialog box 811 of the user interface 81 of the real-time messaging software 8, and the response information in response to the dialogue information is input by the user 12 by utilizing the dialog box 911 of the user interface 91 of the real-time messaging software 9, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database 3 by the service module 2 and/or read by the service module 2 from the database 3, and/or, the dialogue information is immediately input and/or attached by the at least one user 11 utilizing the dialog box 811 of the user interface 81 of the real-time messaging software 8, and the response information is immediately input and/or attached by the user 12 utilizing the dialog box 911 of the user interface 91 of the real-time messaging software 9.

The database 3 operates with the service module 2 and can store the dialogue information and/or the exchanging information, and/or the response information.

In this embodiment, the real-time messaging software 8 is LINE, and the real-time messaging software 9 is WeChat.

As the real-time messaging software 8 is LINE, the at least one users 11 use the user interface 81 of friend ID and/or group ID of the real-time messaging software 8, and, according to the instruction message 813 of the service mode displayed in the user interface 81, input an operation message in the user dialog 811; and, after the service module 2 receives the instruction message 613, an initial operation is performed, and the messaging service and/or business service of the service mode provided by the user 12 account ID of the group ID and/or the friend ID of the real-time messaging software 8 is activated.

After the messaging service and/or business service of the service mode is activated, a service action is performed. The at least one users 11 uses the dialog box 811 of the user interface 81 of friend ID and/or group ID of the real-time messaging software 8 to input dialogue information.

The service module 2 receives the dialogue information and displays the dialogue information on the user interface 91 of the real-time messaging software 9 for the user 12.

The response information in response to the dialogue information in the dialogue box 811 input by the at least one user 11 is input in the dialog box 911 of the user interface 91 of the real-time messaging software 9, WeChat, by the user 12 to provide the service mode of the information service and/or the business services, wherein the user dialogue box 811, the instruction message 813, and the dialogue box 911 of the real-time messaging software, WeChat, are simultaneously displayed on the user interface 81 of the real-time messaging software 8, LINE, wherein the user dialogue box 911 of the real-time messaging software 9, WeChat, and the user dialogue box 811 of the real-time messaging software 8, LINE, are simultaneously displayed on the user interface 91 of the real-time messaging software 9, WeChat, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database 3 by the service module 2 and/or read by the service module 2 from the database 3, and/or, the dialogue information is immediately input and/or attached by the at least one user 11 utilizing the dialog box 811 of the user interface 81 of the real-time messaging software 8, and the response information is immediately input and/or attached by the user 12 utilizing the dialog box 911 of the user interface 91 of the real-time messaging software 9.

In other words, the real-time messaging software 8, LINE, and the real-time messaging software 9, WeChat, are integrated into the application, respectively, an user utilizing LINE can immediately communicate with an user using WeChat across platforms. That is, an user utilizing the application integrating the login of the real-time messaging software, LINE, can not only communicate with an user using LINE to provide the message service and/or the business services, but also communicate with an user using another real-time messaging software, WeChat, across platforms.

Therefore, the information processing system and method of the present invention not only can provide the message service and/or the business services between the users using the same real-time messaging software, such as LINE, but also between different users using the different real-time messaging software, such as LINE, WeChat.

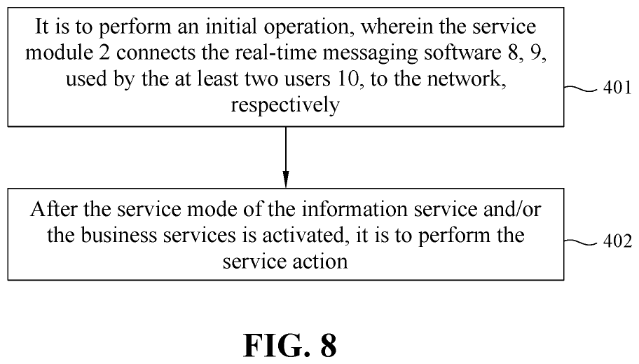

FIG. 8 is a flowchart to illustrate another embodiment of the information processing method by utilizing the embodiment of the information processing system of the present invention in FIG. 7. As shown in FIG. 8, step 401 is to perform an initial operation, wherein the service module 2 connects the real-time messaging software 8, 9, used by the at least two users 10, to the network, respectively; and then proceed to Step 402.

Step 402 is to perform service action; after the service mode of the information service and/or the business services is activated, it is to perform the service action.

The at least two users 10 can input information by using the dialog box 811 of the user interface 81 of the real-time messaging software 8, and the dialog box 911 of the user interface 91 of the real-time messaging software 9 connected to the internet, respectively, to immediately communicate with each other.

The service module 2 would proceed the input information to let the at least two users 10 use the dialog box 811 of the user interface 81 of the real-time messaging software 8, or the dialog box 911 of the user interface 91 of the real-time messaging software 9 to input the dialogue information and/or the response information to proceed the dialogue information service and/or the information-exchanged service, or to proceed the business services such as customer service, psychological consulting services, numerology consulting services, legal consulting services, medical information services, commodity inquiry services, commodity sales services, financial loans, financial commodity information services, chat matching services, etc., provided by an user 12 of one party of the at least two users 10 for at least one user 11 of the other party of the at least two users 10, wherein the dialogue information is input by the at least one user 11 of the at least two users 10 by utilizing the dialog box 811 of the user interface 81 of the real-time messaging software, and the response information in response to the dialogue information is input by the user 12 by utilizing the dialog box 911 of the user interface 91 of the real-time messaging software 9, and wherein the dialogue information and/or the response information can be text messages/files, and/or, picture messages/files, and/or, voice messages/files, and/or multimedia messages/files, depending on the actual implementation of the present invention.

The dialogue information and/or the response information can be saved in a database 3 by the service module 2 and/or read by the service module 2 from the database 3, and/or, the dialogue information is immediately input and/or attached by the at least one user 11 utilizing the dialog box 811 of the user interface 81 of the real-time messaging software 8, and the response information is immediately input and/or attached by the user 12 utilizing the dialog box 911 of the user interface 91 of the real-time messaging software 9.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An information processing method, applicable to the network real-time messaging software environment, comprising the following steps:
performing an initial operation, wherein at least one real-time messaging communication software used by at least two users is connected to a network; and
performing a service action, wherein the at least two users use the at least one real-time messaging software connected to internet to proceed a message service of dialogue information and/or exchanging information between each other by utilizing a dialog box of an user interface of the at least one real-time messaging software, or to proceed business services provided by one party of the at least two users for the other party of the at least two users.

2. The information processing method as claimed in claim 1, wherein the at least one real-time messaging software is the same real-time messaging software.

3. The information processing method as claimed in claim 1, wherein the at least one real-time messaging software comprises two real-time messaging software, and the two software are the same real-time messaging software.

4. The information processing method as claimed in claim 1, wherein one of the at least two users can input information by using the dialog box of the user interface of the at least one real-time messaging software to get one-to-one live service experience on the message service provided by the other of the at least two users.

5. The information processing method as claimed in claim 1, wherein the at least two users use the at least one real-time messaging software connected to internet to proceed at least one service of the business services provided by one party of the at least two users for the other party of the at least two users, and wherein the at least one service is at least one of the customer service, psychological consulting services, numerology consulting services, legal consulting services, medical information services, commodity inquiry services, commodity sales services, financial loans, financial commodity information services, and chat matching services.

6. An information processing method, applicable to the network real-time messaging software environment, comprising:
a service module, wherein the service module connects at least one real-time messaging software used by at least two users to a network, and performs a service action, and wherein the at least two users use the at least one real-time messaging software connected to internet to proceed a message service of dialogue information and/or exchanging information between each other by utilizing a dialog box of an user interface of the at least one real-time messaging software, or to proceed business services provided by one party of the at least two users for the other party of the at least two users; and
a database, wherein the database operates with the service module, and stores the dialogue information and/or the exchanging information.

7. The information processing system as claimed in claim 6, wherein the at least one real-time messaging software is the same real-time messaging software.

8. The information processing system as claimed in claim 6, wherein the at least one real-time messaging software comprises two real-time messaging software, and the two software are the same real-time messaging software.

9. The information processing system as claimed in claim 6, wherein one of the at least two users can input information by using the dialog box of the user interface of the at least one real-time messaging software to get one-to-one live service experience on the message service provided by the other of the at least two users.

10. The information processing system as claimed in claim 6, wherein the at least two users use the at least one real-time messaging software connected to internet to proceed at least one service of the business services provided by one party of the at least two users for the other party of the at least two users, and wherein the at least one service is at least one of the customer service, psychological consulting services, numerology consulting services, legal consulting services, medical information services, commodity inquiry services, commodity sales services, financial loans, financial commodity information services, and chat matching services.
